(19) United States
(12) Patent Application Publication
(10) Pub. No.: US 2004/0091781 A1
(43) Pub. Date: May 13, 2004

(54) Lithium secondary battery and method for producing the same

(75) Inventors: Miyuki Nakai, Izumi-shi (JP); Masashi Shoji, Osaka-shi (JP); Emiko Igaki, Amagasaki-shi (JP); Masakazu Tanahashi, Osaka-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., LTD., Kadoma-shi (JP)

(21) Appl. No.: 10/704,008

(22) Filed: Nov. 7, 2003

(30) Foreign Application Priority Data
Nov. 7, 2002 (JP) 2002-323458

(51) Int. Cl. H01M 4/48; C01G 45/12; C01G 51/04; C01G 53/04; C01G 31/02

(52) U.S. Cl. 429/231.1; 423/594.15; 29/623.1; 423/594.4; 423/594.6; 423/599; 423/594.8

(57) ABSTRACT

A lithium secondary battery of the present invention includes: a positive electrode containing a positive active substance capable of reversibly occluding and releasing lithium; a negative electrode containing a negative active substance capable of reversibly occluding and releasing lithium; and an electrolyte having lithium conductivity, wherein the positive active substance contains an oxide including lithium and transition metal, and a composition ratio among the lithium, the transition metal and oxygen in the oxide is in at least one selected from the following states:

a: oxygen is insufficient with respect to a stoichiometric ratio established among the lithium, the transition metal, and the oxygen,

b. lithium is excessive with respect to the stoichiometric ratio established among the lithium, the transition metal, and the oxygen.

### BACKGROUND OF THE INVENTION

1. Field of the Invention

The present invention relates to a lithium secondary battery and a method for producing the same.

2. Description of the Related Art

A lithium secondary battery generally includes a positive electrode containing a positive active substance capable of reversibly occluding and releasing lithium (Li), a negative electrode containing a negative active substance reversibly occluding and releasing Li, and an electrolyte having Li conductivity. Hitherto, a complex oxide, such as LiCoO₂, LiMn₂O₄, and LiNiO₂, containing lithium and transition metal mainly have been used and studied as positive active substances.

However, in the case where positive active substances as described above are used in a lithium secondary battery, Li is generated, which cannot contribute to charging/discharging any more during initial charging/discharging. More specifically, there is a problem that an irreversible capacity is generated. One of the reasons for the generation of an irreversible capacity is an electrochemical side reaction (herein, a chemical reaction that does not contribute to charging/discharging of a battery will be referred to as a side reaction) such as the decomposition of an electrolyte at a negative electrode during initial charging. Due to this side reaction, the capacity balance between the positive electrode and the negative electrode may be disturbed, decreasing the amount of electricity that can be used for charging/discharging, i.e., decreasing the capacity of a battery. Furthermore, in the case where the capacity balance between the positive electrode and the negative electrode is disturbed, the potential of a battery case that also functions as a negative terminal may exceed the dissolution potential of iron or the like (for example, about 3.2 V with respect to Li, in the case of iron) during overdischarging in which the potential of the positive electrode becomes equal to that of the negative electrode. When the potential of the battery case exceeds the dissolution potential, the battery case is corroded, and an electrolyte and the like may leak out of the case.

In order to solve the above-mentioned problem, a technique of placing a metal lithium foil in the vicinity of a negative electrode is disclosed in JP 05(1993)-144472 A and others. According to this method, by supplying a negative active substance with Li from the metal lithium foil, utilizing the potential difference between the metal lithium and the negative active substance and the gradient of a lithium concentration, Li that can be used for charging/discharging is held in the negative active substance. However, according to this method, it is necessary to use unstable metal lithium with high activity, and such metal lithium is difficult to handle and manage in the course of production.

### SUMMARY OF THE INVENTION

Therefore, with the foregoing in mind, it is an object of the present invention to provide a lithium secondary battery having excellent properties in which, by using a positive active substance capable of preventing the capacity balance between the positive electrode and the negative electrode from being disturbed during initial charging/discharging, the battery capacity is unlikely to decrease and the potential of the negative electrode is unlikely to increase during overdischarging, and a method for producing the lithium secondary battery.

In order to achieve the above-mentioned object, a lithium secondary battery according to the present invention includes: a positive electrode containing a positive active substance capable of reversibly occluding and releasing lithium; a negative electrode containing a negative active substance capable of reversibly occluding and releasing lithium; and an electrolyte having lithium conductivity, wherein the positive active substance contains an oxide including lithium and transition metal, and a composition ratio among the lithium, the transition metal and oxygen in the oxide is in at least one selected from the following states:

a: oxygen is insufficient with respect to a stoichiometric ratio established among the lithium, the transition metal, and the oxygen; and

b. lithium is excessive with respect to the stoichiometric ratio established among the lithium, the transition metal, and the oxygen.

A method for producing a lithium secondary battery according to the present invention includes

(i) forming a positive electrode containing a positive active substance that contains an oxide including lithium and transition metal, in which a composition ratio among the lithium, the transition metal, and oxygen in the oxide is in at least one selected from the following states a and b:

a: oxygen is insufficient with respect to a stoichiometric ratio established among the lithium, the transition metal, and the oxygen; and

b. lithium is excessive with respect to the stoichiometric ratio established among the lithium, the transition metal, and the oxygen, by performing at least one selected from the following (A) and (B):

(A) heat-treating a first material containing at least one compound selected from a lithium compound, a transition metal compound, and a lithium-transition metal complex compound; and

(B) inserting lithium into a second material containing at least one compound selected from a lithium compound and a lithium-transition metal complex compound;

(ii) forming a negative electrode containing a negative active substance capable of reversibly occluding and releasing lithium; and

(iii) positioning an electrolyte having lithium conductivity between the formed positive electrode and the formed negative electrode.

These and other advantages of the present invention will become apparent to those skilled in the art upon reading and understanding the following detailed description with reference to the accompanying figures.

### BRIEF DESCRIPTION OF THE DRAWINGS

FIG. 1 is a schematic cross-sectional view showing an exemplary lithium secondary battery of the present invention.

FIG. 2 illustrates an exemplary method for producing a lithium secondary battery of the present invention.

FIGS. 3A and 3B are schematic views illustrating the exemplary method for producing a lithium secondary battery of the present invention.

FIG. 4 is a graph showing a relationship between the discharge time, and the potentials of a positive electrode and a negative electrode, measured in an example.

FIG. 5 is a graph showing a relationship between the discharge time and the potentials of a positive electrode and a negative electrode, measured in a comparative example.

### DESCRIPTION OF THE PREFERRED EMBODIMENTS

Hereinafter, the present invention will be described by way of illustrative embodiments with reference to the drawings.

First, a lithium secondary battery (hereinafter, merely referred to as a “battery”) of the present invention will be described.

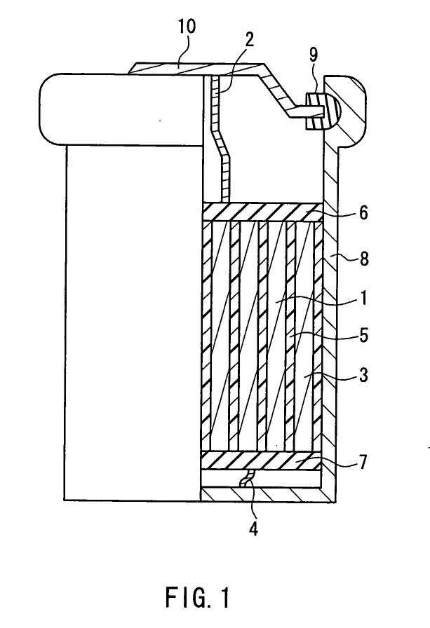

FIG. 1 is a schematic view showing an exemplary lithium secondary battery of the present invention. The battery shown in FIG. 1 includes a positive electrode 1 containing a positive active substance capable of reversibly occluding and releasing Li, a negative electrode 3 containing a negative active substance capable of reversibly occluding and releasing Li, and an electrolyte having Li conductivity. In the battery shown in FIG. 1, the positive electrode 1 and the negative electrode 3 are stacked so that a separator 5 made of an insulating material is interposed therebetween. The separator 5 is, for example, a porous thin film, and an electrolyte having Li conductivity is held in pores of the separator 5. Therefore, Li exchange involved in charging and discharging can be performed via the separator 5, while the positive electrode 1 and the negative electrode 3 are electrically insulated by the separator 5.

The battery of the present invention is characterized by the positive active substance contained in the positive electrode. The positive active substance in the battery of the present invention contains an oxide containing Li and transition metal. Furthermore, the composition ratio among Li, transition metal, and oxygen in the above-mentioned oxide is in at least one selected from the following states a and b.

a: oxygen is insufficient with respect to the stoichiometric ratio established among Li, transition metal, and oxygen (hereinafter, unless otherwise described, the stoichiometric ratio established among Li, transition metal, and oxygen will be merely referred to as a “stoichiometric ratio”).

b: lithium is excessive with respect to the above-mentioned stoichiometric ratio.

In other words, the positive active substance in the battery of the present invention contains an oxide in a state where oxygen is insufficient with respect to the above-mentioned stoichiometric ratio, and/or in a state where lithium is excessive with respect to the above-mentioned stoichiometric ratio.

Generally, in a lithium secondary battery, an irreversible capacity is generated at a negative electrode during initial charging/discharging. Therefore, there is a possibility that the capacity balance between the positive electrode and the negative electrode is disturbed, and the capacity (saturated reversible capacity, hereinafter, merely referred to as a “battery capacity”) that actually can be used for charging/discharging decreases compared with the capacity as designed. In contrast, in the lithium secondary battery of the present invention, the above-mentioned positive active substance can prevent disturbance of the capacity balance between the positive electrode and the negative electrode during initial charging/discharging. Therefore, a lithium secondary battery with high characteristics can be obtained, in which a battery capacity is unlikely to decrease, and the potential of the negative electrode is unlikely to increase during overdischarging (i.e., a battery case is unlikely to be dissolved during overdischarging). As a specific mechanism of suppressing the disturbance of the capacity balance, for example, the following is considered: the above-mentioned positive active substance supplies the negative electrode with Li corresponding to at least a part of the irreversible capacity generated on the negative electrode side during initial charging/discharging. Such a mechanism is considered to be difficult in a conventional positive active substance satisfying the stoichiometric ratio.

The initial charging/discharging herein refers to charging/discharging that is performed initially after a battery is formed and performed several times (e.g., about 2 to 5 times) following the initial time. At this time, there is no particular limit to a temperature at which charging/discharging is performed. For example, charging/discharging may be performed at room temperature or in a range of about 10° C. to 60° C. Furthermore, the irreversible capacity herein refers to the capacity generated during initial charging/discharging, which cannot contribute to charging/discharging of a battery. For example, the difference between the initial charge capacity and the discharge capacity after the initial charging/discharging can be regarded as an irreversible capacity.

The positive active substance (hereinafter, merely referred to as a “positive active substance of the present invention”) used in the battery of the present invention will be shown specifically. The positive active substance of the present invention may contain an oxide having a composition represented by, for example, Formula: LiₓM_{y}O_{(z-β)} as an oxide containing Li and transition metal. Furthermore, the positive active substance of the present invention may contain an oxide having a composition represented by, for example, Formula: Li_{(x+α)}M_{y}O_{z}, or an oxide having a composition represented by, for example, Formula: Li_{(x+α)}M_{y}O_{(z-β)}, as an oxide containing Li and transition metal. The positive active substance may contain a plurality of oxides having different kinds of compositions among the above-mentioned three kinds of compositions. It should be noted that M is at least one element selected from the transition metals. The transition metal is IIIa, IVa, Va, VIa, VIIa, VIII, Ib, or IIB-group element (Group 3 to 12 according to the new IUPAC name). In the above Formulas, x, y, and z are natural numbers satisfying the stoichiometric ratio established among Li, M, and O; α is a numerical value satisfying Formula: 0<α; and β refers to a numerical value satisfying Formula: 0<β<z.

The oxide having a composition represented by Formula: LiₓM_{y}O_{(z-β)} corresponds to the above-mentioned state a. The oxide having a composition represented by Formula: Li_{(x+α)}M_{y}O_{z} corresponds to the above-mentioned state b. The oxide having a composition represented by Formula: Li_{(x+α)}M_{y}O_{(z-β)} corresponds to both the states a and b.

There is no particular limit to α, as long as it is a numerical value satisfying Formula: 0<α. Above all, a is preferably a numerical value satisfying Formula: 0<α/x≦0.4, and more preferably a numerical value satisfying Formula: 0<α/x≦0.2. There is no particular limit to β, as long as it is a numerical value satisfying Formula: 0<β<z. Above all, β is preferably a numerical value satisfying Formula: 0</x≦0.2, and more preferably a numerical value satisfying 0<β/x≦0.1.

α and β may be numerical values satisfying at least one selected from the following Formulas (1) to (3), in the case where an irreversible capacity generated during initial charging/discharging is 6% of the total capacity of the lithium secondary battery.

δ/250≦α/x≦δ/150 (1)

δ/500≦β/x≦δ/300 (2)

δ/250≦(α+2β)/x≦δ/150 (3)

The total capacity of the lithium secondary battery is the capacity of a battery in the case where it is assumed that an irreversible capacity is not generated at all. For example, the total capacity can be obtained from the amount of positive and negative active substances when the lithium secondary battery is produced. More specifically, in the case where the capacity of the positive active substance is larger than that of the negative active substance, for example, the capacity of the negative active substance before the commencement of charging/discharging may be used.

Actually, the value of δ is greatly influenced mainly by a material for the negative active substance. For example, in the case where a carbon material such as graphite is used for the negative active substance, δ% is, for example, in a range of about 2% to 8%, and mostly in a range of about 3% to 5%. In the case where an alloy material containing silicon (Si) and the like is used for the negative active substance, δ% is, for example, in a range of about 6% to 26%, and mostly in a range of 8% to 24%.

In other words, for example, in the case where the negative active substance contains a carbon material, α and β may be numerical values satisfying at least one selected from the following Formulas (4) to (6).

2/250≦α/x≦8/150 (4)

2/500≦β/x≦8/300 (5)

2/250≦(α+2β)/x<8/150 (6)

Above all, α and β may be numerical values satisfying at least one selected from the following Formulas (4)′ to (6)′.

3/250≦α/x≦5/150 (4)′

3/500≦β/x≦5/300 (5)′

3/250≦(α+2β)/x≦5/150 (6)′

Similarly, in the case where the negative active substance contains at least one element selected from Si, tin (Sn), and zinc (Zn), for example, α and β may be numerical values satisfying at least one selected from the following Formulas (7) to (9).

6/250≦α/x≦26/150 (7)

6/500≦β/x≦26/300 (8)

6/250≦(α+2β)/x≦26/150 (9)

Above all, α and β may be numerical values satisfying at least one selected from the following Formulas (7)′ to (9)′.

8/250≦α/x≦24/150 (7)′

8/500≦β/x≦24/300 (8)′

8/250<(α+2β)/x≦24/150 (9)′

For example, in the case where a carbon material is used for the negative active substance, δ% is not always in a range of 3% to 5% or in a range of 2% to 8%. δ% may be out of these ranges depending upon the kind of a carbon material and the kind of an electrolyte. An actually measured value may be applied for δ%.

In the positive active substance of the present invention, the kind of transition metal M is not particularly limited. For example, at least one element selected from Co, Mn, Ni, Fe, Cr, and V may be used. Above all, at least one element selected from Co, Mn, and Ni is preferably used, and Co is more preferably used. As the positive active substance using these elements, for example, Li_{(1+α)}CoO_{(2-β)}, LiCoO_{(2-β)}, Li_{(1+α)}CoO₂, Li_{(1+α)}NiO_{(2-β)}, Li_{(1+α)}Mn₂O_{(4-β)}, Li_{(1+α)}FeO_{(2-β)} and the like can be used. The positive active substance of the present invention may contain plural kinds of these oxides, as well as only one kind of an oxide. α and β only need to satisfy at least one range of the above-mentioned ranges.

The positive active substance of the present invention may contain N, Al, P, Mg, and the like, in addition to the above-mentioned oxide containing Li and transition metal.

Next, another member in the battery of the present invention will be described.

The configuration of the positive electrode 1 is not particularly limited, as long as it contains the above-mentioned positive active substance, and a positive electrode with a general configuration may be used. For example, the positive electrode 1 may have a configuration in which a positive active substance layer containing the above-mentioned positive active substance is formed on a positive collector made of a metal foil of Al, Ni, or the like. The positive active substance layer may contain a conducting agent for enhancing the conductivity of a positive electrode, a binder for holding a positive active substance, etc. on a positive collector, and the like. A general material may be used for the conducting agent. For example, a carbon material such as graphite, difficult-to-graphitize carbon, and the like may be used. A general material also may be used for the binder. Examples of the binder include polyvinylidene fluoride, polytetrafluoroethylene (PTFE), tetrafluoroethylene-hexafluoropropylene copolymer (FEP), and the like.

The configuration of the negative electrode 3 is not particularly limited, as long as it contains a negative active substance capable of reversibly occluding and releasing Li, and a general negative electrode may be used. For example, the negative electrode 3 may have a configuration in which a negative active substance layer containing a negative active substance is formed on a negative collector made of a metal foil of Cu, Ni, or the like. Examples of the negative active substance include a carbon material such as graphite, difficult-to-graphitize carbon, and the like, and an alloy material containing at least one element selected from Si, Sn, and Zn. Above all, in the case of using an alloy material containing Si, or Ti as well as Si, a lithium secondary battery with a higher capacity can be obtained. The negative active substance layer may contain a conducting agent for enhancing the conductivity of a negative electrode and a binder for holding the negative active substance on a negative collector, in the same way as in the positive active substance layer. For the conducting agent and the binder, the same materials as those in the positive electrode may be used.

In the case of using an alloy material containing at least one element selected from Si, Sn, and Zn as the negative active substance, the negative active substance layer may be in a shape of a thin film. In the case where the negative active substance layer is in a shape of a thin film, it is preferable that the negative active substance contains Si, and it also is preferable that Si is in an amorphous state or in a low crystalline state.

The material and configuration of the separator 5 are not particularly limited, as long as it is electrically insulated, and can hold an electrolyte having Li conductivity. A general separator may be used. For example, a porous thin film, in which minute pores are formed, made of polyolefin such as polyethylene and polypropylene may be used. The thickness of the separator 5 is, for example, in a range of 15 μm to 30 μm.

There is no particular limit to the electrolyte, as long as it has Li conductivity. In the case of a battery including a separator as shown in FIG. 1., an electrolyte solution may be used, in which a Li-containing salt (e.g., LiPF₆, LiClO₄, LiBF₄, etc.) is dissolved in a non-aqueous solvent (e.g., carbonate solvents such as ethylene carbonate (EC), ethyl methyl carbonate (EMC), diethyl carbonate (DEC), dimethyl carbonate (DMC), propylene carbonate (PC), etc.; γ-lactones such as γ-butyrolactone (γ-BL); and the like). In this case, the concentration of the Li-containing salt may be set to be, for example, in a range of about 0.3 mol/l to 2 mol/l. In addition, as the electrolyte, a polymer electrolyte made of polyethylene oxide, a gel polymer, etc.; a solid electrolyte made of a γ-type lithium phosphate, a lithium sulfide compound, etc.; and the like may be used.

The battery shown in FIG. 1 further includes a sealing member 10 that also functions as a positive terminal, a positive lead 2 for electrically connecting the positive electrode 1 to the sealing member 10, a gasket 9 for electrically insulating a battery case 8 and the sealing member 10 from each other, and ensuring the airtightness of the battery case 8, a negative lead 4 for electrically connecting the negative electrode 3 to the battery case 8 that also functions as a negative terminal, and insulating plates 6 and 7. Materials generally used for a lithium secondary battery may be used for these members. Furthermore, the configuration of these members, the positional relationship therebetween, and the like are not particularly limited, and may be the same as those in a general lithium secondary battery. These members are not necessarily contained in the battery, and can be omitted, if possible. Furthermore, the battery may include another member in addition to these members, if required.

The battery of the present invention is not limited to a cylindrical battery as shown in FIG. 1. The battery of the present invention can have various shapes such as a prismatic shape, a coin shape, a stack shape, etc. Furthermore, the use of the battery is not particularly limited, and the battery can be used for various purposes, such as a power supply for portable equipment, a household power supply, a power supply for an automobile, etc.

Next, a method for producing a lithium secondary battery of the present invention will be described.

The method for producing a lithium secondary battery of the present invention includes:

(i) forming a positive electrode containing a positive active substance that contains an oxide including lithium and transition metal, in which a composition ratio of the lithium, the transition metal, and oxygen in the oxide is in at least one selected from the above-mentioned states a and b;

(ii) forming a negative electrode containing a negative active substance capable of reversibly occluding and releasing lithium; and

(iii) placing an electrolyte having lithium conductivity between the formed positive electrode and the formed negative electrode.

According to such a production method, a lithium secondary battery with high characteristics can be obtained, in which a battery capacity is unlikely to decrease and the potential of a negative electrode is unlikely to increase during overdischarging.

First, the process (i) will be described.

The process (i) only needs to include at least one selected from (A) heat-treating a first material containing at least one compound selected from a lithium compound, a transition metal compound, and a lithium-transition metal complex compound in a reducing atmosphere; and (B) inserting lithium into a second material containing at least one compound selected from a lithium compound and a lithium-transition metal complex compound.

There is no particular limit to the method of heat treatment in the process (A). The first material may be heated up to a predetermined temperature, using a heater, a muffle furnace, a dielectric heating furnace, etc., and may be kept for a predetermined period of time. The heat treatment temperature is not necessarily required to be constant, and may be varied during heat treatment, if required. Furthermore, the temperature of heat treatment may be varied depending upon the kind of a compound contained in the first material. The temperature of heat treatment is, for example, in a range of 300° C. to 1200° C. More specific ranges of the temperature of heat treatment will be described later.

Regarding the reducing atmosphere in the process (A), there is no particular limit to the composition, pressure, and the like of gas to be contained, as long as an oxygen partial pressure is low (for example, the oxygen partial pressure is 10⁻⁵ Pa or less). Above all, the reducing atmosphere preferably is filled with inactive gas such as nitrogen and argon. The reducing atmosphere may contain hydrogen and carbon monoxide as gas having a reducing property, if required.

In the process (B), there is no particular limit to a method for inserting lithium into the second material. For example, lithium may be inserted electrochemically. More specifically, the following may be performed: the second material is used as a working electrode and a fifth material containing metal lithium is used as a counter electrode; and a current is applied between the working electrode and the counter electrode in a solution containing lithium ions.

The working electrode may be obtained, for example, by forming a layer made of a second material on a metal foil such as Cu. The second material may be pelletized. The counter electrode may be obtained, for example, by forming a layer made of a fifth material on a metal foil of Ni or the like. The fifth material is not particularly limited, as long as it contains metal lithium. For example, metal lithium, a material including a Li-occluding alloy, a Li compound, and the like may be used. It is preferable that the layer made of the second material is opposed to the layer made of the fifth material in a solution. There is no particular limit to the solution containing lithium ions, as long as it contains as little water as possible. For example, a solution in which LiPF₆ is dissolved in a carbonate solvent that is a non-aqueous solvent may be used. In this case, the concentration of the solution is, for example, in a range of about 0.3 mol/l to 2 mol/l.

The lithium compound used for the first and second materials is not particularly limited, as long as it contains lithium. For example, Li₂CO₃, Li₂O, LiOH, and the like may be used.

There is no particular limit to the transition metal compound used for the first material, as long as it contains transition metal. For example, Co₃O₄, Co(OH)₂, CoCo₃, and the like may be used.

The lithium-transition metal complex compound used for the first and second materials are not particularly limited, as long as it contains Li and transition metal. For example, LiCoO₂, LiNiO₂, LiMn₂O₄, LiV₂O₅, LiMnO₂, and the like may be used. In the case of using an oxide containing Li and transition metal, its composition ratio may or may not satisfy the stoichiometric ratio. For example, after forming an oxide containing an excessive amount of Li exceeding the stoichiometric ratio in the process (B), the process (A) may be performed. After forming an oxide containing O in an amount that does not satisfy the stoichiometric ratio in the process (A), the process (B) may be performed. In other words, in the case of performing both the processes (A) and (B), the order of performing them is not particularly limited. Either of the processes (A) and (B) may be performed earlier.

In the first material, at least one compound selected from a lithium compound, a transition metal compound, and a lithium-transition metal complex compound needs to contain O. In the second material, at least one compound selected from a lithium compound and a lithium-transition metal compound needs to contain O.

The kind of the transition metal is not particularly limited. For example, at least one element selected from Co, Mn, Ni, Fe, Cr, and V may be used. Above all, it is preferable to use at least one element selected from Co, Mn, and Ni. It is particularly preferable to use Co.

A more specific example of such processes will be described.

According to the production method of the present invention, for example, the process (i) may include the process (p) of forming an oxide having a composition represented by Formula: LiₓM_{y}O_{(z-β)} by heat-treating a compound having a composition represented by Formula: LiₓM_{y}O_{z} in a reducing atmosphere. Herein, M is at least one element selected from transition metal; x, y, and z are natural numbers satisfying the stoichiometric ratio established among Li, M, and O; and β is a numerical value satisfying Formula: 0<β<z.

The temperature of heat treatment in the process (p) may be, for example, in a range of 300° C. to 1000° C., and preferably in a range of 600° C. to 1000° C. At 300° C. or lower, there is a possibility that oxygen deficiency may not occur.

According to the production method of the present invention, for example, the process (i) may include the process (q) of forming an oxide having a composition represented by Formula: LiₓM_{y}O_{(z-β)} by heat-treating a third material containing a lithium compound and a transition metal compound in a reducing atmosphere. Herein, M, x, y, z, and β are the same as those in the process (p).

The temperature of heat treatment in the process (q) may be, for example, in a range of 600° C. to 1200° C., and preferably in a range of 600° C. to 1100° C. At 600° C. or lower, there is a possibility that oxygen deficiency may not occur. The lithium compound and the transition metal compound contained in the third material may be the same as the compounds contained in the first material and the like.

According to the production method of the present invention, for example, the process (i) may include the process (r) of forming an oxide having a composition represented by Formula: Li_{(x+α)}M_{y}O_{z} by inserting lithium into a compound having a composition represented by Formula: LiₓM_{y}O_{z}. Herein, M, x, y, and z are the same as those in the process (p). α is a numerical value satisfying Formula: 0<α.

According to the production method of the present invention, for example, the process (i) may include the process (P) of forming a compound having a composition represented by Formula: LiₓM_{y}O_{(z-β)} by heat-treating a compound having a composition represented by Formula: LiₓM_{y}O_{z} in a reducing atmosphere, and the process (s) of forming an oxide having a composition represented by Formula Li_{(x+α)}M_{y}O_{(z-β)} by inserting lithium into a compound having a composition represented by Formula: LiₓM_{y}O_{(z-β)} formed as described above. Herein, M, x, y, z, α, and β are the same as those in the processes (p) and (r). The temperature of heat treatment in the process (P) may be the same as that in the process (p).

According to the production method of the present invention, for example, the process (i) may include the process (Q) of forming a compound having a composition represented by Formula: LiₓM_{y}O_{(z-β)} by heat-treating a fourth material containing a lithium compound and a transition metal compound in a reducing atmosphere, and the process (t) of forming an oxide having a composition represented by Formula: Li_{(x+α)}M_{y}O_{(z-β)} by inserting lithium into a compound having a composition represented by Formula: LiₓM_{y}O_{(z-β)} formed as described above. Herein, M, x, y, z, α, and β are the same as those in the processes (p) and (r). The temperature of heat treatment in the process (Q) may be the same as that in the process (q). The fourth material may be the same as the third material.

According to the production method of the present invention, for example, the process (i) may include the process (R) of forming a compound having a composition represented by Formula: Li_{(x+α)}M_{y}O_{z} by inserting lithium into a compound having a composition represented by Formula: LiₓM_{y}O_{z}, and the process (u) of forming an oxide having a composition represented by Formula Li_{(x+α)}M_{y}O_{(z-β)} by heat-treating a compound having a composition represented by Formula: Li_{(x+α)}M_{y}O_{z} formed as described above. Herein, M, x, y, z, α, and β are the same as those in the processes (p) and (r). The temperature of heat treatment in the process (u) may be the same as that in the process (p).

The values of α and β in the oxide formed according to the above-mentioned methods may be in any of the ranges described with respect to the battery of the present invention.

In the process (i), there is no particular limit to the method for forming a positive electrode using a positive active substance formed as described, and a general method may be used. For example, the obtained positive active substance may be formed into powder, and mixed with a conducting agent, a binder, a solvent, and the like to form a slurry. The slurry may be applied to a positive collector, followed by drying. After drying, the positive active substance may be pressed with a roller or the like. The above-mentioned materials may be used for the conducting agent, the binder, and the positive collector. N-methylpyrrolidone (NMP), alcohol, water, and the like may be used as the solvent. The conducting agent and the binder may be added, if required.

If a band-shaped positive collector is used, a positive electrode can be formed continuously. In this case, the obtained band-shaped positive electrode may be formed to a predetermined size before forming a battery in the process (iii).

Next, the process (ii) will be described. In the process (ii), there is no particular limit to a method for forming a negative electrode, and a general method may be used. For example, in the same way as in the case of the positive electrode in the process (i), a negative active substance may be formed as powder, and mixed with a conducting agent, a binder, a solvent, and the like to obtain a slurry. The slurry may be applied to a negative collector, followed by drying. After drying, the negative active substance may be pressed with a roller. The materials as described above may be used for the conducting agent, the binder, the negative collector, and the solvent. The conducting agent and the binder may be added, if required.

In the case where the negative active substance contains at least one element selected from Si, Sn, and Zn, a thin film of a negative active substance may be formed on a negative collector to obtain a negative electrode. There is no particular limit to a method for forming a thin film. Sputtering, CVD, vapor deposition, plating, or the like may be used. In the case where the negative active substance is an alloy or a compound containing Si, it is preferable to form a thin film so that Si is in an amorphous state or in a low crystalline state.

In the same way as in the positive electrode, if a band-shaped negative collector is used, a negative electrode can be formed continuously. In this case, the obtained band-shaped electrode may be formed to a predetermined size before forming a battery in the process (iii). It is not necessarily required that the process (ii) is performed simultaneously with or continuously from the process (i). For example, the negative electrode may be previously formed separately from the positive electrode and used in the process (iii). Similarly, it is not necessarily required that the process (iii) is performed simultaneously with or continuously from the process (i) and/or the process (ii).

Next, the process (iii) will be described. In the process (iii), there is no particular limit to a method for forming a lithium secondary battery, using the positive and negative electrodes formed in the processes (i) and (ii). A general method may be used. For example, in the case of a cylindrical battery as shown in FIG. 1, first, the positive electrode 1 and the negative electrode 3 are stacked so that the separator 5 is interposed therebetween to obtain a stack. Then, the stack thus formed is wound to obtain a cylindrical electrode group. The electrode group is accommodated in the cylindrical battery case 8 in which a negative lead 4 and an insulating plate 7 are previously placed. At this time, the negative electrode 3 and the negative lead 4 are electrically connected to each other. Then, an electrolyte solution having Li conductivity is poured as an electrolyte in the battery case 8. Next, the insulating plate 6 and the positive lead 2 are placed, and the battery case 8 may be sealed with a sealing plate 10 and a gasket 9. Thus, the battery as shown in FIG. 1 can be obtained. The above-mentioned materials as described above may be used for the separator 5, the electrolyte solution, etc.

In addition, a solid electrolyte having Li conductivity may be used as an electrolyte. In this case, a positive electrode and a negative electrode are stacked so that the solid electrolyte is interposed therebetween to form a stack, and this stack may be accommodated in a case.

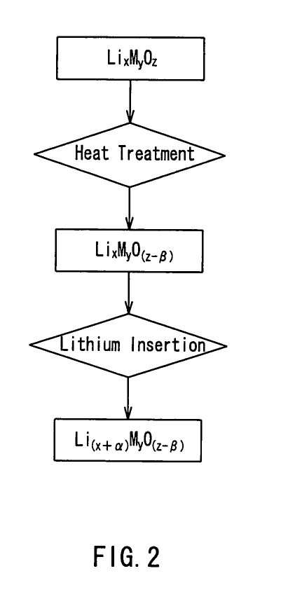

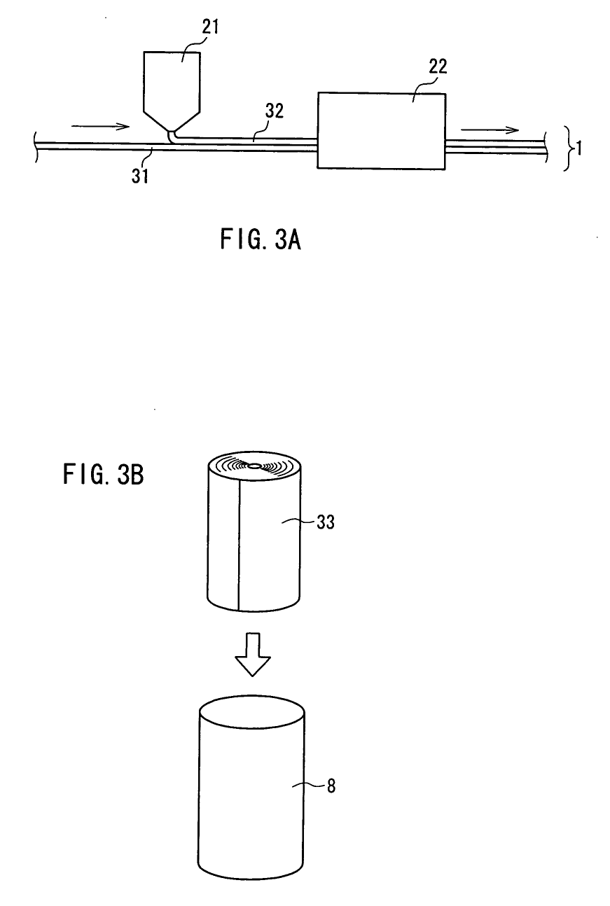

FIGS. 2 to 3B show an exemplary production method of the present invention.

First, a positive active substance is formed as shown in FIG. 2. As a material, a lithium-transition metal complex compound LiₓM_{y}O_{z} is prepared, and heat-treated at a temperature in a range of 300° C. to 1000° C., whereby a compound LiₓM_{y}O_{(z-β)} is formed. Subsequently, lithium is inserted into the compound to form an oxide Li_{(x+α)}M_{y}O_{(z-β)} as a positive active substance.

The positive active substance is mixed with a conducting agent, a binder, and a solvent to obtain a slurry. Then, as shown in FIG. 3A, the slurry is applied to a band-shaped positive collector 31 with a coater 21 to form a positive active substance layer 32. Then, the entire layer is dried in a drying apparatus 22, whereby a positive electrode 1 can be obtained.

A negative electrode may be produced in the same way as in the positive electrode in FIG. 3A. At this time, a negative collector may be used in place of the positive collector, and a negative active substance may be used in place of the positive active substance.

Next, as shown in FIG. 3B, the positive electrode, the separator, and the negative electrode are stacked successively and wound to obtain an electrode group 33. The electrode group 33 is accommodated in a battery case 8, and thereafter, an electrolyte solution having Li conductivity is poured as an electrolyte in the battery case 8. An insulating plate, a lead, and the like are put in place, and the battery case 8 is sealed, whereby a battery as shown in FIG. 1 can be obtained.

### EXAMPLE

Hereinafter, the present invention will be described in detail by way of an illustrative example. It should be noted that the present invention is not limited to the following example.

In the present example, batteries as shown in FIG. 1 were produced using Samples 1 to 10 (among them, Samples 8 to 10 are comparative examples) produced as described below, and evaluated for battery characteristics.

Sample 1

As a lithium-transition metal complex compound, LiCoO₂ (produced by Honjo Chemical Corporation) having a composition satisfying the stoichiometric ratio was used. Then, LiCoO₂ was palletized to form a working electrode. Metal lithium was used as a counter electrode. The working electrode and the counter electrode were immersed in a EC/EMC mixed solvent (concentration: 1 mol/l) containing LiBF₄ (produced by Mitsubishi Chemical Corporation), and a constant current (5.5 mA for 1 g of complex compound) was applied between the electrodes for one hour. Thereafter, the lithium-transition metal complex compound was collected from the working electrode. The composition of the compound was examined by atomic absorption spectrometry to confirm that an oxide Li_{1.02}CoO₂ was formed. In this oxide, Li was excessive with respect to the stoichiometric ratio, and a and α/x indicating the degree of excess was 0.02. This is a value corresponding to the case where the irreversible capacity of a negative electrode is 4% of the total volume of the battery during initial charging/discharging. More specifically, if the oxide is used as a positive active substance, even when the irreversible capacity of the negative electrode is 4% of the total volume of the battery, a positive electrode has an excessive amount of Li corresponding to the irreversible capacity, which is considered to prevent the disturbance of the capacity balance between the positive electrode and the negative electrode during initial charging/discharging.

Next, the above-mentioned oxide was used as a positive active substance, and mixed with acetylene black (produced by Denki Kagaku Kogyo K. K.) as a conducting agent, polyvinylidene fluoride (PVDF) (produced by Kureha Chemical Industry Co., Ltd.) as a binder, and NMP as a solvent to obtain a slurry. The slurry was applied to both surfaces of a positive collector made of an aluminum foil with a knife coater. Thereafter, the resultant positive collector was dried and rolled to produce a positive electrode.

A negative electrode was produced separately from the positive electrode. As a negative active substance, a carbon material (MICROCARBO, produced by Kansai Coke and Chemicals Co., Ltd.) obtained by sintering an organic polymer compound was used. Furthermore, the carbon material was mixed with a conducting agent, a binder, and a solvent similar to those of the positive electrode to obtain a slurry. The slurry was applied to both surfaces of a negative collector made of a copper foil in the same way as in the positive electrode, and dried and rolled to produce a negative electrode.

The positive electrode and the negative electrode produced as described above were stacked so that a porous separator made of polyethylene (CELGARD with a thickness of 20 μm, produced by Asahi Kasei Co., Ltd.) was interposed therebetween to obtain a stack. Then, the stack thus obtained was wound to produce a spiral electrode group.

The electrode group was accommodated in a battery case, and an electrolyte solution in which LiPF₆ as an electrolyte was dissolved in a EC/EMC mixed solvent (concentration 1 mol/l) was poured in the battery case, whereby a lithium secondary battery as shown in FIG. 1 was produced. The size of the battery thus produced was set to be ICR17500 size described in JIS-C8711, and the battery capacity was set to be 800 mAh.

Sample 2

As a lithium-transition metal complex compound, LiNi_{0.56}Mn_{0.20}Cu_{0.24}O₂ having a composition satisfying the stoichiometric ratio was synthesized and prepared. Lithium was inserted into this compound in the same way as in Sample 1. The composition of the oxide thus obtained was examined in the same way as in Sample 1 to confirm that an oxide Li_{1.02}Ni_{0.56}Mn_{0.20}Co_{0.24}O₂ was formed. In this oxide, Li was excessive with respect to the stoichiometric ratio, and a and a/x indicating the degree of excess was 0.02. This is a value corresponding to the case where the irreversible capacity of a negative electrode is 4% of the total volume of the battery during initial charging/discharging. A battery was produced in the same way as in Sample 1, using the above-mentioned oxide as a positive active substance.

Sample 3

LiCoO₂ used in Sample 1 was heat-treated (argon atmosphere, 850° C., 10.5 hours) with a carbon crucible. The composition of the oxide obtained by heat treatment was examined in the same way as in Sample 1 to confirm that an oxide LiCoO_{1.99} was formed. In this oxide, O was insufficient with respect to the stoichiometric ratio, and β and β/x indicating the degree of deficiency was 0.01. This is a value corresponding to the case where the irreversible capacity of a negative electrode is 4% of the total volume of the battery during initial charging/discharging. A battery was produced in the same way as in Sample 1, using the above-mentioned oxide as a positive active substance.

Sample 4

Li₂CO₃ (produced by Honjo Chemical Corporation) as a lithium compound, and Co₃O₄ (produced by Seido Kagaku Kogyo) as a transition metal compound were used. Li₂CO₃ and Co₃O₄ were mixed in a molar ratio of 3:2, and the mixture was heat-treated (argon atmosphere, 850° C., 10.5 hours) with a carbon crucible. The composition of the oxide obtained by heat treatment was examined in the same way as in Sample 1 to confirm that an oxide LiCoO_{1.99} was formed. A battery was produced in the same way as in Sample 1, using the oxide as a positive active substance.

Sample 5

LiCoO₂ used in Sample 1 was heat-treated (argon atmosphere, 850° C., 10.5 hours) with a carbon crucible. Then, a working electrode containing a compound obtained by heat treatment was formed in the same way as in Sample 1. Then, lithium was inserted into the working electrode thus formed in the same way as in Sample 1 to obtain an oxide. The composition of the oxide thus obtained was examined in the same way as in Sample 1 to confirm that an oxide Li_{0.01}CoO_{1.995} was formed. In the oxide, Li was excessive with respect to the stoichiometric ratio, O was insufficient with respect thereto, α and α/x indicating the degree of excess was 0.01, and β and β/x indicating the degree of deficiency was 0.005. This is a value corresponding to the case where the irreversible capacity of a negative electrode is 4% of the total volume of the battery during initial charging/discharging. A battery was produced in the same way as in Sample 1, using the above-mentioned oxide as a positive active substance.

Sample 6

Li₂CO₃ and Co₃O₄ were prepared in the same way as in Sample 4. Li₂CO₃ and Co₃O₄ were mixed in a molar ratio of 3:2, and the mixture was heat-treated (argon atmosphere, 850° C., 10.5 hours) with a carbon crucible. Then, a working electrode containing a compound obtained by heat treatment was formed in the same way as in Sample 1. Then, lithium was inserted into the working electrode thus formed in the same way as in Sample 1 to obtain an oxide. The composition of the oxide thus obtained was examined in the same way as in Sample 1 to confirm that an oxide Li_{1.01}CoO_{1.995} was formed. A battery was produced in the same way as in Sample 1, using the above-mentioned oxide as a positive active substance.

Sample 7

LiCoO₂ used in Sample 1 was heat-treated (argon atmosphere, 900° C., 10.5 hours) with a carbon crucible. The composition of an oxide obtained by heat treatment was examined in the same way as in Sample 1 to confirm that an oxide LiCoO_{1.965} was formed. In this oxide, O was insufficient with respect to the stoichiometric ratio, and β and β/x indicating the degree of deficiency was 0.035. This is a value corresponding to the case where the irreversible capacity of a negative electrode is 14% of the total volume of the battery during initial charging/discharging. A battery was produced in the same way as in Sample 1, using the above-mentioned oxide as a positive active substance.

In Sample 7, a negative active substance was produced by the following method. Si particles (average particle size: 20 μm, produced by Kojundo Kagaku Co., Ltd.) and sponge-shaped Ti (produced by Furuuchi Chemical Corporation) were mixed (weight ratio 6:4) in an argon atmosphere. Thereafter, the mixture was alloyed by a gas atomizing method. Then, the alloy thus obtained was subjected to mechanical milling (rotation speed: 6000 rpm, 3 hours) using a vibration ball mill, whereby Si—Ti alloy material with an average particle size of 2 μm to 3 μm was produced. The alloy material thus produced was used as a negative active substance.

Sample 8 (Comparative Example)

A battery was produced in the same way as in Sample 1, using LiCoO₂ that was a compound satisfying the stoichiometric ratio as a positive active substance.

Sample 9 (Comparative Example)

A battery was produced in the same way as in Sample 1, using LiNi_{0.56}Mn_{0.20}Co_{0.24}O₂ that was a compound satisfying the stoichiometric ratio as a positive active substance.

Sample 10 (Comparative Example)

A battery was produced in the same way as in Sample 1, using LiCoO₂ that was a compound satisfying the stoichiometric ratio as a positive active substance, and using the Si—Ti alloy material used in Sample 7 as a negative active substance.

Each battery produced as described above was evaluated for battery characteristics during overdischarging. The evaluation of battery characteristics was performed as follows. First, the battery thus produced was subjected to initial charging. The initial charging was performed by allowing a constant current of 160 mA (0.2 CmA) to flow until a battery voltage reached 4.2 V After the initial charging, the battery was kept at 45° C. in a thermostat, and aging was performed for 2 weeks. Then, the temperature of the thermostat was decreased to 20° C., and the battery was allowed to stand in the thermostat for one week. The battery was charged with a constant current (160 mA) until the battery voltage reached 4.2 V. Thereafter, the battery was discharged with a constant current (160 mA) until the battery voltage reached 3.0 V. Thereafter, while the battery was being connected to a resistor of 1 kΩ, the battery was allowed to stand for 30 days in an environment at 60° C. At this time, the measurement of the potential (overdischarging behavior) of positive and negative electrodes continued, using metal lithium as a reference electrode,

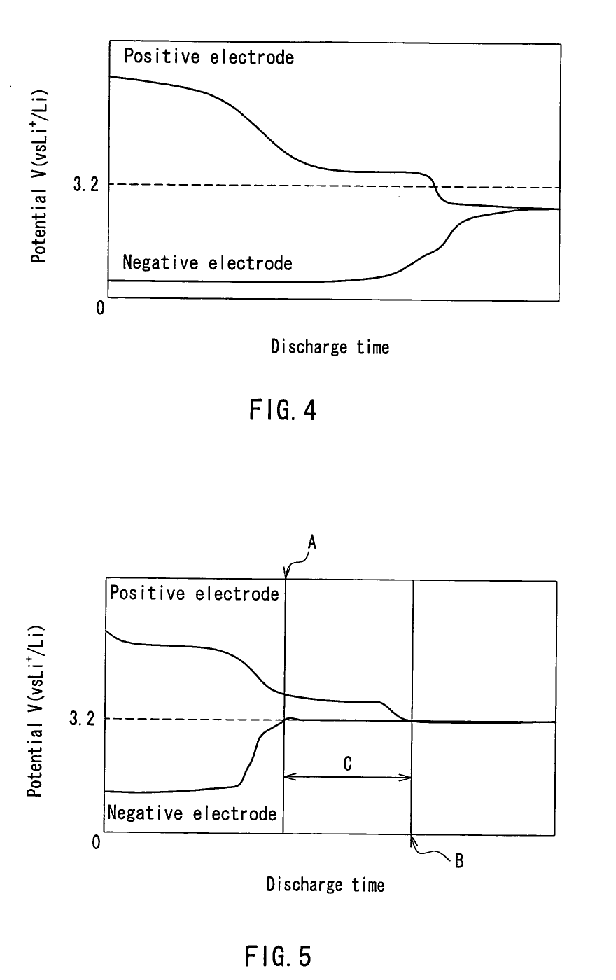

FIG. 4 shows the results obtained by measuring the overdischarging behavior of Sample 1. FIG. 5 shows the results obtained by measuring the overdischarging behavior of Sample 8. Horizontal axes in FIGS. 4 and 5 represent a discharge time. The measurement was started from a time when the resistor of 1 kΩ was attached to the battery. It is understood from FIG. 5 that the potential (based on lithium) of the negative electrode increased to 3.2 V along with overdischarging in Sample 8 (Comparative Example). It is considered that the battery case of Sample 8 started being dissolved at a point A in FIG. 5, because the dissolution potential in the case of using iron for a battery case is about 3.2 V with respect to lithium. It is also considered that the dissolution stopped at a point B in FIG. 5, because the potential of the positive electrode became substantially the same as that of the negative electrode at the point B in FIG. 5. More specifically, in Sample 8, it is considered that the dissolution of the battery case proceeded during a period C shown in FIG. 5. In contrast, in Sample 1 shown in FIG. 4, the potential of the negative electrode increased only to about 2.65 V along with overdischarging. Therefore, in Sample 1, the battery case is not dissolved even during overdischarging.

Next, Tables 1 and 2 show the potential (negative electrode reaching potential) that the negative electrode reached during overdischarging of each sample, and the discharge capacity before the battery voltage reached 3V during initial discharging.

TABLE 1

| Sample No | 1 | 2 | 3 | 4 | 5 | 6 | 7 |
|---|---|---|---|---|---|---|---|
| Negative electrode | 2.65 | 2.71 | 2.6 | 2.65 | 2.63 | 2.66 | 2.63 |
| reaching potential | | | | | | | |
| (V) | | | | | | | |
| Discharge capacity | 794.6 | 793.9 | 794.9 | 794.2 | 795.1 | 794.5 | 795.2 |
| (mAh) | | | | | | | |

TABLE 2

| Sample No | 8 | 9 | 10 |
|---|---|---|---|
| Negative electrode | 3.2 | 3.2 | 3.21 |
| reaching potential | | | |
| (V) | | | |
| Discharge capacity | 769.3 | 765.0 | 687.8 |
| (mAh) | | | |

As shown in Tables 1 and 2, in Samples 1 to 7 (Examples), the negative electrode reaching potential was about 2.6 V to 2.7 V based on lithium. Thus, the negative electrode reaching potential was suppressed to a lower value compared with Samples 8 to 10 (Comparative Examples) in which the negative electrode reaching potential was 3.2 V or more. In Samples 1 to 7, it is understood that the negative electrode reaching potential was low even during overdischarging, and thus, the inconvenience such as dissolution of a battery case was suppressed.

Furthermore, in Samples 1 to 7, the discharge capacity of the battery also exhibited values larger than those of Samples 8 to 10. The irreversible capacity of a battery is generated mainly during initial (in particular, first) charging/discharging. Therefore, in Samples 1 to 7, the disturbance of the capacity balance between the positive electrode and the negative electrode is suppressed.

In the present example, the case has been mainly described in which transition metal is Co. However, the same results can be obtained in the case where Mn, Ni, Fe, and the like are used alone as transition metal, and in the case where a part of the transition metal is replaced with another transition metal.

As described above, according to the present invention, a lithium secondary battery with excellent characteristics can be provided, in which a battery capacity is unlikely to decrease, and the potential of a negative electrode is unlikely to increase during overdischarging, and a method for producing the lithium secondary battery. The lithium secondary battery of the present invention can be used for various purposes such as a power supply for portable equipment, a household power supply, a power supply for an automobile, etc.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A lithium secondary battery, comprising:
a positive electrode containing a positive active substance capable of reversibly occluding and releasing lithium;
a negative electrode containing a negative active substance capable of reversibly occluding and releasing lithium; and
an electrolyte having lithium conductivity,
wherein the positive active substance contains an oxide including lithium and transition metal, and
a composition ratio among the lithium, the transition metal and oxygen in the oxide is in at least one selected from the following states:
a: oxygen is insufficient with respect to a stoichiometric ratio established among the lithium, the transition metal, and the oxygen; and
b. lithium is excessive with respect to the stoichiometric ratio established among the lithium, the transition metal, and the oxygen.

2. The lithium secondary battery according to claim 1, wherein the oxide has a composition represented by Formula: LiₓM_{y}O_{(z-β)}, a composition represented by Formula Li_{(x+α)}M_{y}O_{z}, or a composition represented by Formula: Li_{(x+α)}M_{y}O_{(z-β),}
where M is at least one element selected from transition metal;
x, y and z are natural numbers satisfying the stoichiometric ratio established among Li, M, and O,
α is a numerical value satisfying Formula: 0<α; and
β is a numerical value satisfying Formula: 0<β<z.

3. The lithium secondary battery according to claim 2, wherein α is a numerical value satisfying Formula: 0<α/x≦0.4.

4. The lithium secondary battery according to claim 2, wherein β is a numerical value satisfying Formula: 0<α/x≦0.2.

5. The lithium secondary battery according to claim 2, wherein an irreversible capacity generated during initial charging/discharging is δ% of a total capacity of the lithium secondary battery, and
α and β are numerical values satisfying at least one selected from the following formulas:
δ/250<α/x≦6/150
δ/500≦β/x≦6/300
δ/250≦(α+2β)x≦δ/150

6. The lithium secondary battery according to claim 2, wherein the negative active substance contains a carbon material, and
α and β are numerical values satisfying at least one selected from the following formulas:
2/250≦α/x≦8/150
2/500≦β/x<8/300
2/250≦(α+2β)/x≦8/150

7. The lithium secondary battery according to claim 2, wherein the negative active substance contains at least one element selected from Si, Sn, and Zn, and
α and β are numerical values satisfying at least one selected from the following formulas:
6/250≦α/x≦26/150
6/500≦β/x≦26/300
6/250≦(α+2β)/x<26/150

8. The lithium secondary battery according to claim 1, wherein the transition metal is at least one element selected from Co, Mn, and Ni.

9. The lithium secondary battery according to claim 8, wherein the transition metal is Co.

10. A method for producing a lithium secondary battery, comprising:
(i) forming a positive electrode containing a positive active substance that contains an oxide including lithium and transition metal, in which a composition ratio among the lithium, the transition metal, and oxygen in the oxide is in at least one selected from the following states a and b:
a: oxygen is insufficient with respect to a stoichiometric ratio established among the lithium, the transition metal, and the oxygen; and
b. lithium is excessive with respect to the stoichiometric ratio established among the lithium, the transition metal, and the oxygen, by performing at least one selected from the following (A) and (B):
(A) heat-treating a first material containing at least one compound selected from a lithium compound, a transition metal compound, and a lithium-transition metal complex compound; and
(B) inserting lithium into a second material containing at least one compound selected from a lithium compound and a lithium-transition metal complex compound;
(ii) forming a negative electrode containing a negative active substance capable of reversibly occluding and releasing lithium; and
(iii) positioning an electrolyte having lithium conductivity between the formed positive electrode and the formed negative electrode.

11. The method for producing a lithium secondary battery according to claim 10, wherein the step (i) includes
(p) forming the oxide having a composition represented by Formula: LiₓM_{y}O_{(z-β)} by heat-treating a compound having a composition represented by Formula: LiₓM_{y}O_{z} in a reducing atmosphere,
where M is at least one element selected from transition metal,
x, y, and z are natural numbers satisfying a stoichiometric ratio established among Li, M, and O, and
β is a numerical value satisfying Formula: 0<β<z.

12. The method for producing a lithium secondary battery according to claim 11, wherein a temperature of the heat treatment in the (p) is in a range of 300° C. to 1000° C.

13. The method for producing a lithium secondary battery according to claim 10, wherein the step (i) includes
(q) forming the oxide having a composition represented by Formula: LiₓM_{y}O_{(z-β)} by heat-treating a third material containing a lithium compound and a transition metal compound in a reducing atmosphere,
where M is at least one element selected from transition metal,
x, y, and z are natural numbers satisfying a stoichiometric ratio established among Li, M, and O, and
β is a numerical value satisfying Formula: 0<β<z.

14. The method for producing a lithium secondary battery according to claim 13, wherein a temperature of the heat treatment in the (q) is in a range of 600° C. to 1200° C.

15. The method for producing a lithium secondary battery according to claim 10, wherein the step (i) includes
(r) forming the oxide having a composition represented by Formula: Li_{(x+α)}M_{y}O_{z} by inserting lithium into a compound having a composition represented by Formula LiₓM_{y}O_{z},
where M is at least one element selected from transition metal,
x, y, and z are natural numbers satisfying a stoichiometric ratio established among Li, M, and O, and
α is a numerical value satisfying Formula: 0<α.

16. The method for producing a lithium secondary battery according to claim 10, wherein the step (i) includes:
(P) forming a compound having a composition represented by Formula: LiₓM_{y}O_{(z-β)} by heat-treating a compound having a composition represented by Formula: LiₓM_{y}O_{z} in a reducing atmosphere; and
(s) forming the oxide having a composition represented by Formula: Li_{(x+α)}M_{y}O_{(z-β)} by inserting lithium into the compound having a composition represented by Formula: LiₓM_{y}O_{(z-β)},
where M is at least one element selected from transition metal,
x, y, and z are natural numbers satisfying a stoichiometric ratio established among Li, M, and O,
α is a numerical value satisfying Formula: 0<α, and
β is a numerical value satisfying Formula: 0<β<z.

17. The method for producing a lithium secondary battery according to claim 16, wherein a temperature of the heat treatment in the (P) is in a range of 300° C. to 1000° C.

18. The method for producing a lithium secondary battery according to claim 10, wherein the step (i) includes:
(Q) forming a compound having a composition represented by Formula: LiₓM_{y}O_{(z-β)} by heat-treating a fourth material containing a lithium compound and a transition metal compound in a reducing atmosphere; and
(t) forming the oxide having a composition represented by Formula: Li_{(x+α)}M_{y}O_{(z-β)} by inserting lithium into the compound having a composition represented by Formula: LiₓM_{y}O_{(z-β)},
where M is at least one element selected from transition metal,
x, y, and z are natural numbers satisfying a stoichiometric ratio established among Li, M, and O,
α is a numerical value satisfying Formula: 0<α, and
β is a numerical value satisfying Formula: 0<β<z.

19. The method for producing a lithium secondary battery according to claim 18, wherein a temperature of the heat treatment in the (Q) is in a range of 600° C. to 1200° C.

20. The method for producing a lithium secondary battery according to claim 10, wherein the step (i) includes:
(R) forming a compound having a composition represented by Formula: Li_{(x+α)}M_{y}O_{z} by inserting lithium into a compound having a composition represented by Formula: LiₓM_{y}O_{z}; and
(u) forming the oxide having a composition represented by Formula: Li_{(x+α)}M_{y}O_{(z-β)} by heat-treating the compound having a composition represented by Formula: Li_{(x+α)}M_{y}O_{z} in a reducing atmosphere,
where M is at least one element selected from transition metal,
x, y, and z are natural numbers satisfying a stoichiometric ratio established among Li, M, and O,
α is a numerical value satisfying Formula: 0<α, and
β is a numerical value satisfying Formula: 0<β<z.

21. The method for producing a lithium secondary battery according to claim 20, wherein a temperature of the heat treatment in the (u) is in a range of 300° C. to 1000° C.

22. The method for producing a lithium secondary battery according to claim 10, wherein the step (B) is performed by using the second material as a working electrode and a fifth material containing metal lithium as a counter electrode, and applying a current between the working electrode and the counter electrode in a solution containing lithium ions.

23. The method for producing a lithium secondary battery according to claim 10, wherein the transition metal is at least one selected from Co, Ni, and Mn.

24. The method for producing a lithium secondary battery according to claim 10, wherein the lithium compound is at least one selected from Li₂Co₃, Li₂O, and LiOH.

25. The method for producing a lithium secondary battery according to claim 10, wherein the transition metal compound is at least one compound selected from Co₃O₄, Co(OH)₂, and CoCO₃.

26. The method for producing a lithium secondary battery according to claim 10, wherein the lithium-transition metal complex compound is at least one compound selected from LiCoO₂, LiNiO₂, LiMn₂O₄, LiMnO₂, and LiV₂O₅.
